(19) United States
(12) Patent Application Publication
(10) Pub. No.: US 2007/0186263 A1
(43) Pub. Date: Aug. 9, 2007

(54) Analog broadcasting receiving device and DVD recorder having the same

(75) Inventor: Yoshihisa Nakaya, Osaka (JP)

Correspondence Address: MORGAN LEWIS & BOCKIUS LLP, 1111 PENNSYLVANIA AVENUE NW, WASHINGTON, DC, 20004, US

(73) Assignee: Funai Electric Co., Ltd.

(21) Appl. No.: 11/702,230

(22) Filed: Feb. 5, 2007

(30) Foreign Application Priority Data
Feb. 7, 2006 (JP) 2006-030127
Feb. 7, 2006 (JP) 2006-030139

(51) Int. Cl. H04N 5/445; H04N 7/00; G06F 13/00; H04N 11/00; H04N 7/16; H04N 7/173; G06F 3/00

(52) U.S. Cl. 725/132; 725/58; 725/134; 725/133; 725/135; 348/468; 725/152; 725/140

(57) ABSTRACT

An analog broadcasting receiving device includes a receiving portion for receiving a television broadcasting wave, an EPG extracting portion for extracting EPG data from VBI of the television broadcasting wave, a ROM for storing a GCN table that is a list of GCN codes, and a control portion for controlling extracting and outputting the EPG of a broadcasting station stored in the GCN table. The received EPG data is analyzed, and if a new GCN code that is not included in the GCN table is detected, the detected new GCN code is added to the GCN table.

This application is based on Japanese Patent Application No. 2006-030127 filed on Feb. 7, 2006, the contents of which are hereby incorporated by reference.

### BACKGROUND OF THE INVENTION

1. Field of the Invention

The present invention relates to an analog broadcasting receiving device that utilizes an EPG and a DVD (Digital Versatile Disc) recorder equipped with the device.

2. Description of Related Art

Conventionally, there are widespread techniques of superimposing character signals on broadcasting waves of terrestrial analog broadcasting so as to transmit an EPG (Electronic Program Guide) about genre, broadcasting time and the like of broadcasting programs. This EPG is extracted by a broadcasting receiving device such as a television broadcasting receiving device and is displayed on a television screen as a program list. Thus, a televiewer can search his or her favorite program. This broadcasting receiving device is also provided to a video tape recorder, a DVD recorder, an HDD (Hard Disk Drive) recorder or the like.

FIG. 5 is a schematic diagram to show a system structure of a G guide system 100 for displaying an EPG on a television screen. The G guide system 100 in a transmission side converts program guide information prepared by broadcasting companies into a predetermined file format, which is compressed and enciphered. After that, the program guide information is organized by inserting the character signal in VBI (Vertical Blanking Interval) of the television broadcasting wave and is transmitted to broadcasting receiving devices from a transmission device. On the other hand, a receiving side receives the television broadcasting wave by the broadcasting receiving device, extracts the character signal from the VBI as data, which are stored temporarily in a memory or the like. After that, the data are decoded and expanded so that the above mentioned predetermined file is extracted and displayed on the television screen as the program list.

There are various proposals about usages of the EPG. For example, JP-A-2000-101525 discloses a system for store and forward processing of program guide data. According to this document, each broadcasting station provides all station EPG data with its own station data and obtains other stations data from the all station EPG data for delivery. Thus, if a new broadcasting station appears, the EPG can be provided without changing a system of each station.

In addition, JP-A-2001-86425 discloses a program information display device that determines increase or decrease of services from a service description table and an event information table of digital broadcastings.

In addition, JP-A-2004-128883 discloses a digital broadcasting receiving device that supports a new broadcasting station by a channel search in an initial setting of the device or by a follow up channel search while receiving no broadcasting program.

However, the technique disclosed in the above mentioned JP-A-2000-101525 is about the transmission side of the EPG, and the document does not describe about the receiving side. In addition, the technique disclosed in JP-A-2001-86425 can obtain a list of channels that can be received currently, but it cannot support a newly established broadcasting station. Furthermore, although the technique disclosed in JP-A-2004-128883 can receive a broadcasting program of a newly established broadcasting station by the follow up channel search that detects a frequency, the document does not describe about a technique for obtaining the EPG of the new broadcasting station.

As described above, when a new broadcasting station is established, the conventional broadcasting receiving device cannot display the EPG about the broadcasting station although it can receive the broadcasting program by detecting a frequency of the new broadcasting station. It is because that the broadcasting receiving device is provided with a GCN table indicating a list of GCN codes (registry numbers of broadcasting stations), and that only the EPG of broadcasting stations registered in the GCN table is displayed. In order to display the EPG of a newly established broadcasting station, it is necessary to update EPG software in the device, which may increase cost and time.

### SUMMARY OF THE INVENTION

In view of the above described problems, it is an object of the present invention to provide an analog broadcasting receiving device that can display an EPG of a broadcasting station that is newly established after manufacturing of the device. Further, it is another object of the present invention to provide a DVD recorder equipped with the analog broadcasting receiving device.

To attain the above described object, an analog broadcasting receiving device in accordance with one aspect of the present invention includes: a receiving portion for receiving a television broadcasting wave; an EPG extracting portion for extracting EPG data from VBI of the television broadcasting wave; a memory portion for storing a GCN table that is a list of GCN codes; and a control portion for controlling extracting and outputting the EPG of a broadcasting station stored in the GCN table. In addition the analog broadcasting receiving device is characterized by a structure in which the received EPG data is analyzed, and if a new GCN code that is not included in the GCN table is detected, the detected new GCN code is added to the GCN table.

According to this structure, if there is a broadcasting station that is newly established after the analog broadcasting receiving device was manufactured, a GCN code corresponding to the new broadcasting station is detected from the received EPG data so that the GCN table stored in the memory portion can be updated automatically. Thus, an EPG of the newly established broadcasting station can be displayed promptly.

To attain the above described object, an analog broadcasting receiving device in accordance with another aspect of the present invention includes: a receiving portion for receiving a television broadcasting wave; an EPG extracting portion for extracting EPG data from VBI of the television broadcasting wave; a memory portion for storing a GCN table that is a list of GCN codes; and a control portion for controlling extracting and outputting the EPG of a broadcasting station stored in the GCN table. In addition the analog broadcasting receiving device is characterized by a structure in which the received EPG data is analyzed, and if a new GCN code that is not included in the GCN table is detected, the detection result is notified, and the detected new GCN code is added to the GCN table.

According to this structure, if there is a broadcasting station that is newly established after the analog broadcasting receiving device was manufactured, a GCN code corresponding to the new broadcasting station is detected from the received EPG data so that the detection result is sent to the user. When there is an instruction from the user, the GCN table stored in the memory portion is updated so that an EPG of the newly established broadcasting station can be displayed.

Further to attain the above described second object, a DVD recorder equipped with an analog broadcasting receiving device in accordance with other aspect of the present invention includes: a receiving portion for receiving a television broadcasting wave; an EPG extracting portion for extracting EPG data from VBI of the television broadcasting wave; a ROM for storing a GCN table that is a list of GCN codes; and a control portion for controlling extracting and outputting the EPG of a broadcasting station stored in the GCN table. In addition the DVD recorder is characterized by a structure in which the received EPG data is analyzed, and if a new GCN code that is not included in the GCN table is detected, the detected new GCN code is added to the GCN table.

According to the present invention, an EPG of a broadcasting station that is newly established after the device was manufactured can be displayed. Therefore, the user can utilize a latest EPG effectively.

### BRIEF DESCRIPTION OF THE DRAWINGS

FIG. 1 is a block diagram to show a structure of a DVD recorder according to the present invention.

FIG. 2 is a block diagram to show a structure of an EPG extracting portion and a control portion shown in FIG. 1 of the present invention.

FIG. 3 is a flowchart to show an operation of a DVD recorder that supports a newly established broadcasting station according to the present invention.

FIG. 4 is a flowchart to show an operation of another embodiment of the DVD recorder that supports a newly established broadcasting station according to the present invention.

FIG. 5 is a schematic diagram to show a system structure of a conventional G guide system.

### DESCRIPTION OF THE PREFERRED EMBODIMENTS

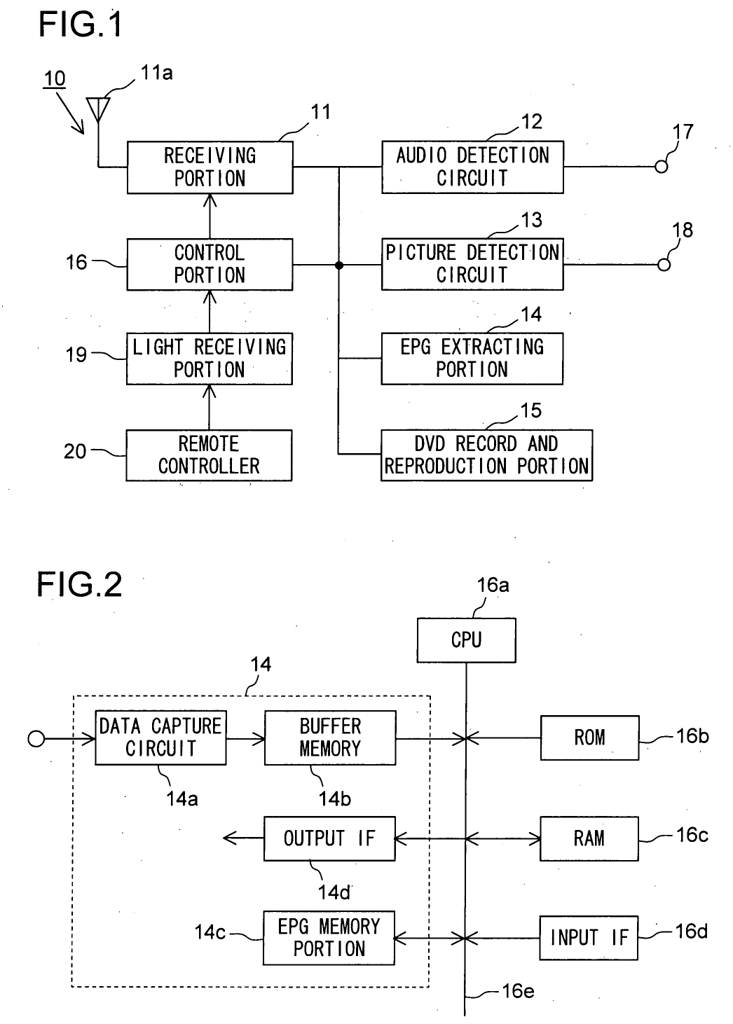

Now, embodiments of the present invention will be described with reference to an example of a DVD recorder equipped with an analog broadcasting receiving device. FIG. 1 is a block diagram to show a structure of a DVD recorder, and FIG. 2 is a block diagram to show a structure of an EPG extracting portion and a control portion shown in FIG. 1. FIGS. 1 and 2 show only structures necessary for describing the present invention, and other structures that are not necessary to describe are omitted. The DVD recorder 10 is made up of a receiving portion 11, an audio detection circuit 12, a picture detection circuit 13, an EPG extracting portion 14, a DVD record and reproduction portion 15, a control portion 16, an audio output terminal 17, a picture output terminal 18, a light receiving portion 19, a remote controller 20 and the like.

The receiving portion 11 is equipped with an antenna 11a, and it has a function as a tuner that receives broadcasting waves from broadcasting stations by the antenna 11a and selecting a desired broadcasting program for receiving. The receiving portion 11 extracts a picture signal and an audio signal in the received broadcasting wave and outputs the picture signal and the audio signal to the picture detection circuit 13 and the audio detection circuit 12, respectively. In addition, the receiving portion 11 outputs the broadcasting wave to the EPG extracting portion 14 for extracting a character signal that is superimposed on the broadcasting wave.

The audio detection circuit 12 detects the audio signal out of the picture signal and the audio signal that are input from the receiving portion 11. This audio signal is amplified by an amplifier circuit (not shown) and is output from the audio output terminal 17. The audio output terminal 17 is connected to a speaker (not shown) of a television broadcasting receiving device or the like.

The picture detection circuit 13 detects the picture signal out of the picture signal and the audio signal that are input from the receiving portion 11. This picture signal is amplified by an amplifier circuit (not shown) and is output from the picture output terminal 18. The picture output terminal 18 is connected to a monitor (not shown) of a television broadcasting receiving device or the like.

The EPG extracting portion 14 obtains the EPG by extracting the character signal that is superimposed on the broadcasting wave and is transmitted. The EPG includes information about a GCN code, a program name of the program, broadcasting date, program start time, program end time, a reservation code, a channel, a genre and the like of the broadcasting station for approximately two weeks, and the information is stored in an EPG memory portion (see FIG. 2).

The DVD record and reproduction portion 15 records the received broadcasting program on a loaded DVD or reproduces data recorded on a DVD.

The control portion 16 drives and controls each portion of the DVD recorder 10 in accordance with a system program and a control program when a tuning operation, a mode selection operation or the like transmitted from the remote controller 20 is input via the light receiving portion 19.

With reference to FIG. 2, the EPG extracting portion 14 and the control portion 16 will be described in detail. As shown in FIG. 2, the EPG extracting portion 14 is made up of a data capture circuit 14a, a buffer memory 14b, an EPG memory portion 14c, an output interface (hereinafter referred to as an IF) 14d and the like. In addition, the control portion 16 is made up of a CPU (Central Processing Unit) 16a, a memory portion including a ROM (Read Only Memory) 16b and a RAM (Random Access Memory) 16c, an input IF 16d and the like. Then, each portion of the EPG extracting portion 14 and each portion of the control portion 16 are connected to each other by bus 16e.

The data capture circuit 14a extracts the character signal from the picture signal input from the receiving portion 11. The character signal is EPG data inserted in a VBI of the picture signal. Then, the data capture circuit 14a performs synchronous reproduction and error correction of the character signal, and the result thereof is stored in the buffer memory 14b temporarily. The buffer memory 14b outputs the stored EPG data on a page basis to the EPG memory portion 14c in accordance with control of the CPU 16a.

The EPG memory portion 14c stores the EPG data that are transmitted from the buffer memory 14b on a page basis, and it updates and stores the EPG at the time when the EPG is transmitted from the transmission device on the transmission side by control of the CPU 16a. The output IF 14d outputs the EPG read out from the EPG memory portion 14c to the monitor.

The CPU 16a works based on a control program stored in the ROM 16b and control data stored in the RAM 16c. The CPU 16a controls a timing of the character signal in the data capture circuit 14a and transmission of data from the data capture circuit 14a to the buffer memory 14b. In addition, the CPU 16a transmits the EPG data stored in the buffer memory 14b temporarily to the EPG memory portion 14c for storing the same on a page basis.

The CPU 16a controls the EPG extracting portion 14 to obtain new EPG data at the time when the EPG is transmitted from the transmission device on the transmission side. Thus, the EPG stored in the EPG memory portion 14c can be updated.

The CPU 16a controls so that the EPG of the broadcasting station registered in the GCN table is extracted and is output. In other words, the EPG of the broadcasting station that is not registered in the GCN table is not extracted and is not displayed on the monitor, therefore. The GCN table is a mapping list of broadcasting station names and GCN codes thereof, which is stored in the ROM 16b. A broadcasting station that had started service at a time point when the DVD recorder was manufactured is registered in the GCN table in advance, but a broadcasting station that starts service after the time point is not registered in the GCN table. Therefore the DVD recorder in the state of shipping cannot display the EPG of a newly established broadcasting station.

In addition, when an instruction for displaying the EPG is input from the remote controller 20, the CPU 16a reads out the EPG from the EPG memory portion 14c and outputs the EPG from the output IF 14d so as to make the monitor display the EPG.

The input IF 16d outputs an operational instruction input via the light receiving portion 19 to the CPU 16a.

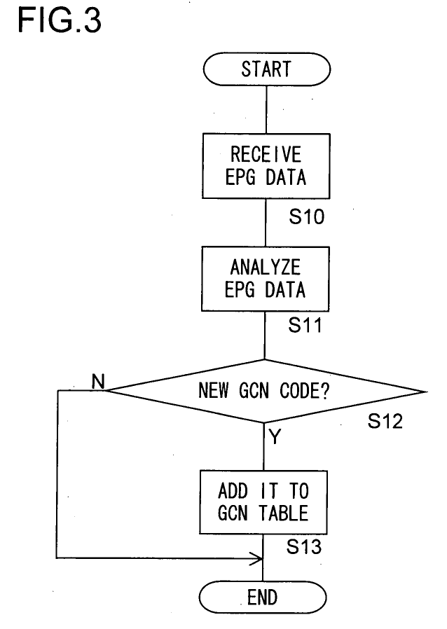

In addition, the control portion 16 performs also a control for the EPG of a newly established broadcasting station to be displayed. Hereinafter, this control will be described. FIG. 3 is a flowchart to show an operation of a DVD recorder 10 that supports a newly established broadcasting station.

First in the step S10, when the EPG data is received, the process goes to the step S11 in which the EPG data are analyzed so that the GCN code is detected. Then, the process goes to the step S12 in which the detected GCN code is compared with a GCN code in the GCN table stored in the ROM 16b. Thus, it is decided whether or not the received EPG data includes a new GCN code that is not included in the GCN table.

If a new GCN code is detected in the step S12, the process goes to the step S13 in which the detected new GCN code is added to the GCN table. Thus, the EPG extracting portion 14 extracts the EPG of a broadcasting station corresponding to the new GCN code, so that the EPG can be displayed on the monitor. When the user operates the remote controller 20 or the like and issues an instruction for displaying the EPG, the EPG including the new broadcasting station is displayed.

In contrast, if a new GCN code is not detected in the step S12, it is decided that there is no broadcasting station that is newly established, and this process is finished. In this case, when an instruction for displaying the EPG is issued, the EPG as normal is displayed.

According to the embodiment described above, if there is a broadcasting station that is newly established after the DVD recorder 10 was manufactured, the GCN code corresponding to the new broadcasting station is detected from the received EPG data. Then, the GCN table stored in the ROM 16b is automatically updated, so that the EPG of the newly established broadcasting station can be displayed promptly. As a result, the user can use the latest EPG effectively.

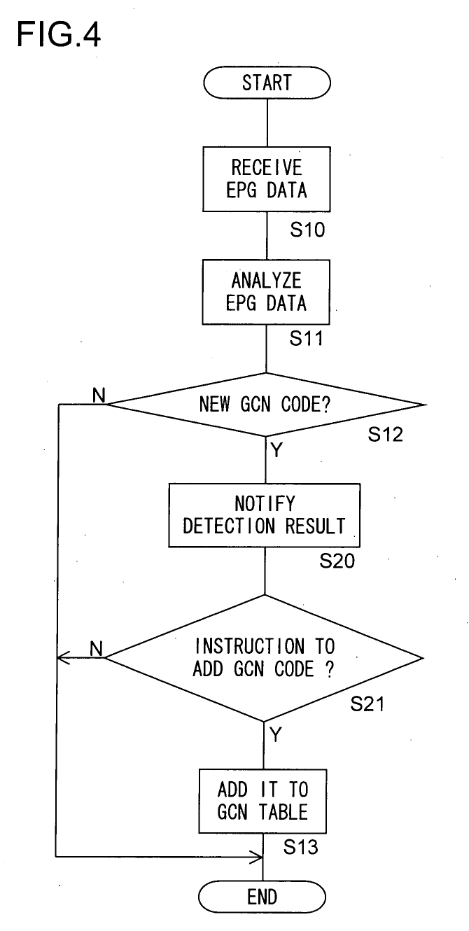

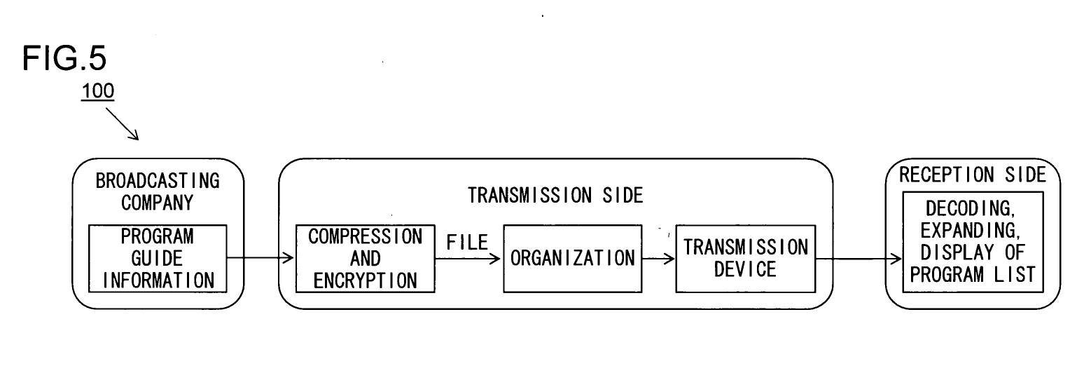

Next, another embodiment of the control for realizing the display of the EPG of a newly established broadcasting station will be described. FIG. 4 is a flowchart to show an operation of another embodiment of the DVD recorder 10 that supports a newly established broadcasting station. Processes similar to the case shown in FIG. 3 are denoted by the same reference numerals, and descriptions thereof will be omitted.

First, the steps from S10 to S12 are executed. If a new GCN code is detected in the step S12, the process goes to the step S20 in which the detection result is notified. This notification may be performed by displaying a message on the monitor. The message may indicate that a new broadcasting station is detected and ask the user whether or not the user will permit the new GCN code to be added to the GCN table, for example.

After that, the process goes to the step S21 in which an input instruction from the user is waited. If an instruction that permits the detected new GCN code to be added is issued, the process goes to the step S13 in which the detected new GCN code is added to the GCN table.

In contrast, if a new GCN code is not detected in the step S12, or if an instruction that does not permit the new GCN code to be added is issued in the step S21, this process is finished.

According to the embodiment described above, if there is a broadcasting station that is newly established after the DVD recorder 10 was manufactured, the GCN code corresponding to the new broadcasting station is detected from the received EPG data. Then, the detection result is notified to the user. If an instruction is issued from the user, the GCN table stored in the ROM 16b is updated so that the EPG of the newly established broadcasting station can be displayed. As a result, the user can use the latest EPG effectively.

Note that the ROM 16b stores a table of frequencies corresponding to all channels defined by the government. On the other hand, the EPG data includes information of the channel. Therefore, if the GCN code of the newly established broadcasting station is detected, the channel and the frequency of the broadcasting station corresponding to the GCN code can be obtained. Therefore, by controlling to receive the frequency of the channel, the user can receive a program of the newly established broadcasting station.

The broadcasting receiving device of the present invention can be provided to a television broadcasting receiving device, a video tape recorder, a DVD recorder, an HDD recorder or the like, and to a combination device of them.

What is claimed is:

1. An analog broadcasting receiving device comprising:
a receiving portion for receiving a television broadcasting wave;
an EPG extracting portion for extracting EPG data from VBI of the television broadcasting wave;
a memory portion for storing a GCN table that is a list of GCN codes; and
a control portion for controlling extracting and outputting the EPG of a broadcasting station stored in the GCN table, wherein
the received EPG data is analyzed, and if a new GCN code that is not included in the GCN table is detected, the detected new GCN code is added to the GCN table.

2. An analog broadcasting receiving device comprising:
a receiving portion for receiving a television broadcasting wave;
an EPG extracting portion for extracting EPG data from VBI of the television broadcasting wave;
a memory portion for storing a GCN table that is a list of GCN codes; and
a control portion for controlling extracting and outputting the EPG of a broadcasting station stored in the GCN table, wherein
the received EPG data is analyzed, and if a new GCN code that is not included in the GCN table is detected, the detection result is notified, and
if an instruction for adding the new GCN code to the GCN table is issued, a process of adding the new GCN code is performed.

3. A DVD recorder equipped with an analog broadcasting receiving device comprising:
a receiving portion for receiving a television broadcasting wave;
an EPG extracting portion for extracting EPG data from VBI of the television broadcasting wave;
a ROM for storing a GCN table that is a list of GCN codes; and
a control portion for controlling extracting and outputting the EPG of a broadcasting station stored in the GCN table, wherein
the received EPG data is analyzed, and if a new GCN code that is not included in the GCN table is detected, the detected new GCN code is added to the GCN table.
